(19) United States
(12) Patent Application Publication
(10) Pub. No.: US 2009/0314197 A1
(43) Pub. Date: Dec. 24, 2009

(54) Automatic Hooking Device And Controlled Release Of Loaded Blocks

(76) Inventor: Angelo Misson, Monfalcone (IT)

Correspondence Address: ST. ONGE STEWARD JOHNSTON & REENS, LLC, 986 BEDFORD STREET, STAMFORD, CT, 06905-5619, US

(21) Appl. No.: 12/488,346

(22) Filed: Jun. 19, 2009

Related U.S. Application Data
(63) Continuation of application No. PCT/EP2007/009125, filed on Oct. 22, 2007.

(30) Foreign Application Priority Data
Dec. 19, 2006 (IT) UD2006A000267

(51) Int. Cl. B66C 1/42; B66C 1/10; B63B 23/02

(52) U.S. Cl. 114/368; 294/110.1; 294/88

(57) ABSTRACT

Automatic hooking device with a block locking mechanism having a automatic hooking means, operated only by the ascending movement of the block that is opportunely guided, hooking means including at least hook clamping means that act on projections and/or the head of block for the hooking of block and, locking means consisting of an automatic locking device in a steadily closed position of the hooking means, actuated by the same ascending movement of block and consisting of a mechanism suitable for assuming and permanently maintaining the clamped closing position of hook clamping means; and release means capable of releasing locking means following a power-assisted or manual command.

### CROSS-REFERENCE TO RELATED APPLICATIONS

The present application is a continuation of pending International patent application PCT/EP2007/009125 filed on Oct. 22, 2007 which designates the United States and claims priority from Italian patent application UD2006A000267 filed on Dec. 19, 2006, the content of which is incorporated herein by reference.

### FIELD OF THE INVENTION

The present invention concerns an automatic hooking device with controlled release for lifting blocks.

The invention also extends to lifeboat cranes installed on board ships, with particular although not exclusive reference to fixed installations, namely without hinged or sliding arms or arms of the compound type.

### BACKGROUND OF THE INVENTION

The working principle of a crane with movable arms, suitable for executing linear, rotary or compound movements is known. In the case of fixed installations, the lifting and the lowering of a pulley tackle takes place without any movement whatsoever of the structure that houses the suspending pulleys of the tackle, thus making it impossible to use the movement of the arm to hold the block either during the movement of the arm, or subsequently when the load reaches its rest position.

In particular, lifeboat cranes are characterised in that the boat must always remain hooked to the blocks of the crane (one or two according to whether the boat has one or two hooks). Therefore, the need also arises that consists in being able to loosen the lifting cables to avoid the formation of permanent twists and/or the damage of said cables if they are permanently held subjected to tension.

Since the lowering of the boats takes place simply by raising the lever that releases the winch brake, it is clear that the same hooking device of the block must also act as a safety device against the accidental lowering of the boat arranged in its rest position on board the ship.

Moreover, the regulations presently in force according to the International Convention for the Safety of Life at Sea (Solas) prescribe that lifeboats may be launched with the ship at any longitudinal (pitch angle) or transverse (roll angle) trim, within the provided maximum limits, including combined together.

Therefore, it is necessary for the hooking device of the block to guarantee a strong and reliable hold of the block in any trim position provided by the regulations and also to allow the opening of the device and the release of the block even when loaded. In strict accordance with the safety requirements, the block must be released without the use of other energy sources, only the force of gravity or permanently stored autonomous energy reserve systems, such as gas pressurised hydraulic devices, may be used.

The reliability of the device and therefore of the crane itself also depends on the possibility that the hooking of the block will take place automatically, namely without the appropriate intervention of the operator, each time the block, and thus the boat, reach their rest position provided during the navigation of the ship. The closest existing solution is disclosed in DE-A-1456118.

There are multiple block locking systems installed on existing cranes, but generally they use the movement of the arms on which the blocks are housed at the end of their maximum path of lift.

In the case of launch systems without movable arms (hereinafter called fixed installations) it is obviously not possible to use these principles.

The aim of this invention is to avoid the aforementioned drawbacks by providing an extremely reliable automatic locking device.

### SUMMARY OF THE INVENTION

The problem is solved with the characteristics of an automatic hooking device with a block locking mechanism.

The present invention also presents particularly advantageous preferred solutions.

The system uses the movement of the block that, by entering into a housing located on the support structure that acts as a guide during the last part of the ascending movement, is arranged in abutment against a mechanical device that acts as a stop and by pushing against said stop it determines the reload of the release device and the contemporary closing of a lever that provides, against said action, the clamping of the block with jaws that determine automatic hooking, irreversibly stabilised until the intervention of the controlled release device (manual and/or with energy reserve).

In this solution it is the movement itself of the block in its housing seat that establishes its automatic hooking and simultaneously the automatic reloading of the energy reserve release device.

The automatic reloading of the block release device can also advantageously be carried out, apart from by means of the movement of the block itself, subordinately by means of the subsequent over-tensioning of the cables when the block reaches the mechanical stop in its housing in the fixed installation.

Advantageously, since the loaded release must also be able to take place with weights of a few dozen tones it is therefore evident that, in addition to the necessary reductions carried out by the mechanical hooking device, a release control system is provided that is power-assisted by a suitable energy reserve device.

Finally, as provided by the regulations and by extension also implemented for the new essential devices for ship safety installations, and precisely for that which is under consideration, a manual type device is also provided for possible emergencies in addition to the power-assisted release device. Said device will consist of a hand-pump with a suitable tank connected to the release device with energy reserve, or of a mechanism with screw-type reduction or a lever directly operated by the operator and directly connected to the levers of the hooking mechanism.

With this solution it is possible to obtain a simple, extremely reliable and safe system at a reasonable cost and above all that only requires minimal maintenance.

The characteristics of strength, reliability and inexpensiveness of the systems for launching lifeboats identify the devices with a hydraulic actuator having an energy reserve with gas pressurised accumulators as the optimal technical choice.

The device obtained in this way synthesizes all these needs and, although it is defined as an optimal solution for the automatic locking of blocks and for the subsequent controlled release, particularly in the case of fixed installations for launching lifeboats, it can also be employed usefully in other types of cranes, possibly also intended for other aims.

This system provides a hooking automatism that does not require the use of movable arms, however it is extremely safe and practical.

### BRIEF DESCRIPTION OF THE DRAWINGS

The device according to the present invention will be now explained with the aid of the attached Figures that illustrate non-limitative examples of certain preferable embodiments, in which:

FIG. 1 represents a vertical transverse schematic view respectively, on the left, in the final lifting position with the hooking mechanism closed and the controlled release device reloaded, in the centre, with the hooking mechanism stably closed and the block rested on the hooks following the release of the cables and finally on the right, at the end of the opening stage of the hooking mechanism following the controlled release. According to a first embodiment the hooking mechanism consists of a transverse arm lever with an intermediate rabbet for the head of the block, keyed to one of two movable opposite hooks of the clamping jaw. A second lever acting as a connecting rod is keyed to the first and second hook of the jaw. In the closing position it is noted that the couple of levers presents the central hinge above the alignment of the hinges with hooks, held in place by an elastic element in such a way that possible vibrations will not allow the intermediate hinge to be lowered below the aforementioned alignment. By releasing the cables, the block leans against the hooks of the blocking jaw and in this configuration aims to force the connection rods further in the their closing position which is contrasted by a suitable mechanical stop made in the support structure. This first embodiment therefore constitutes an illustration both of the hooking mechanism as well as that of hook locking and of controlled release.

FIG. 2 represents a vertical transverse schematic view of a second lever functionally similar to that in FIG. 1 but with the block arranged alternatively, in which the clamping and hooking jaw is also made up of two hooks, symmetric with respect to form and hinging, directed internally and opposite each other. On the opposite side of the respective hinges said hooks have a concave tooth that forms a rebate with said block in such a way that, by loosening the cables after the complete closure of the hooking system, the consequent lowering of the block within the cradle in which it is housed forces the hooks to rotate oppositely towards the interior, locking the block in a way similar to the closing of a jaw, with the effect of clamping said block. In this configuration, the straightening function of the block during its approach and the guide of said block in the subsequent closing movement of the hooking mechanism is in this case also entrusted to a hollow opportunely shaped on the sides of the support structure, that act however advantageously on the two projections of the pin of the block pulley.

FIG. 3 represents a scheme of the controlled release device in one of the possible solutions having a hydraulic power reserve.

### DETAILED DESCRIPTION OF THE INVENTION

In its multiform construction solutions, the automatic hooking and controlled release device for blocks is made up of the following parts:
automatic hooking mechanism (1) by means of hooks (a) with opposite peaks,
hook locking mechanism (a) in closed position
controlled hook release mechanism (a)
manual release mechanism
structure to support the device and block guide (f).

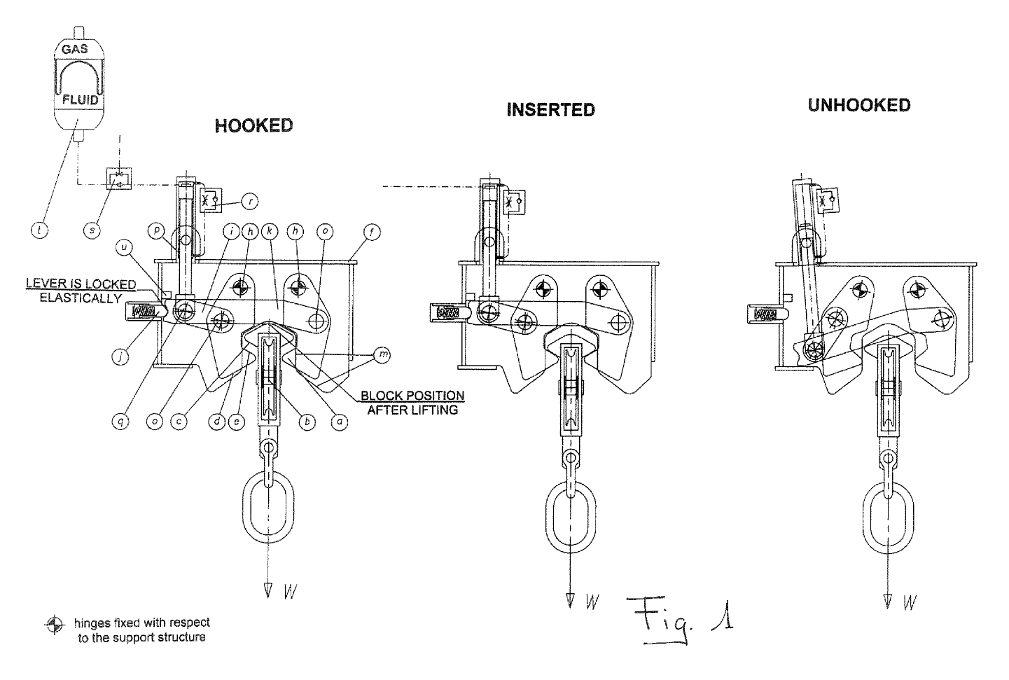

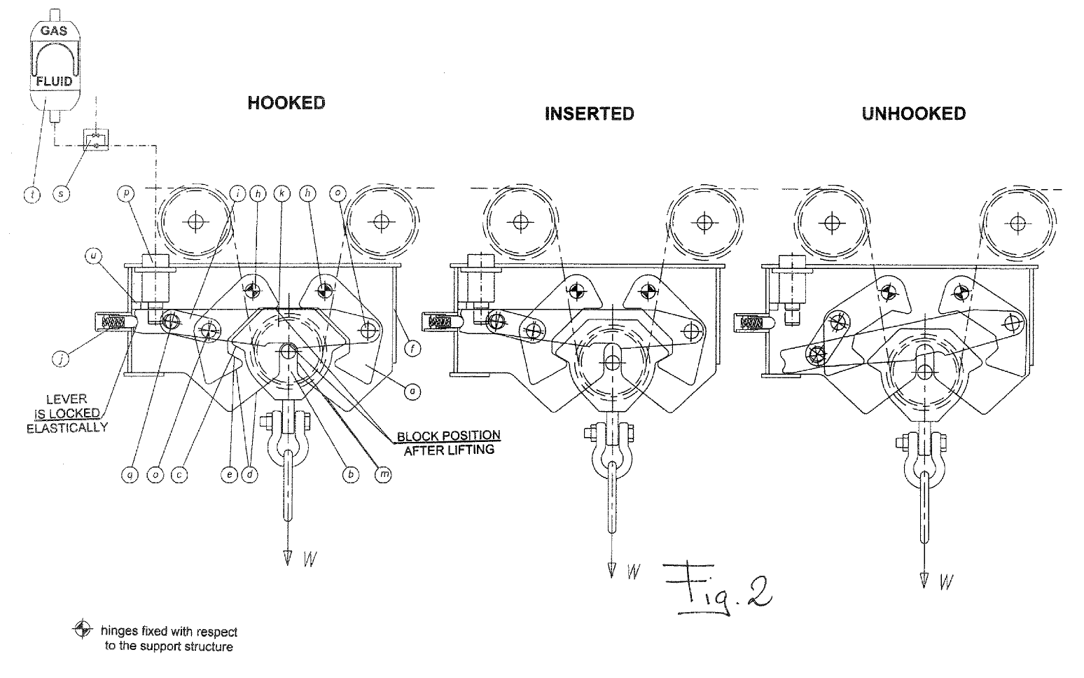

The automatic hooking mechanism consists of one or two hooks (a) connected by a strong pin (h) to the support structure (f) and shaped in such a way as to open automatically under the pressure of the block (b) arranged with suitable holding appendices, obtained on the structure of the block by means of lateral projections of the same (FIG. 2 c), or by means of concave cavities on its sides or suitable mushroom-shaped heads arranged on the upper part of said block (FIG. 1).

The hollow of the hooks (a) will have a lower inclined side (a) that serves to support and centre the holding appendices (c) of the block, when said block is lowered and left to rest on said hooks. The contact surfaces between the hooks (e) and the holding appendices (c) of the block will take a form suitable for allowing the opening of the hooks under the weight of the block and of the load applied to it.

When the holding appendices of the block go beyond the peak made by the joint between the lower surface (d) and the hooking surface (e), the ascending movement of said block will directly or indirectly bring about the simultaneous closing of the hooks and of the locking mechanism of said hooks.

In the cases in which the block is hooked crosswise (FIG. 1) the contact surfaces (c) and (e) will be shaped in such a way as to allow the possible tilting of said block, thus preventing the hooked block from being stretched laterally by the tilted loads.

The form of the hooks and the tilting of said contact surfaces will, moreover, be shaped in such a way that the counter forces necessary to maintain the hooks in a stable closed position will be adequately reduced with respect to the resulting contact forces, in order to limit reasonably the push required from the locking mechanism and to allow the controlled release including when loaded (primary force reduction mechanism).

The upper face of the hollow of the hooks will possibly be shaped in such a way as to force the hooks to assume a centred trim with respect to the appendices of the block, when said block reaches its maximum elevation.

The lower surfaces (d) of the hooks will possibly be shaped in such a way that, by meeting the block when the latter appears at the entry of the hooking mechanism, they will provide for the opening and the centering of the hooks (a) that would possibly not be completely open or misaligned with respect to the entrance position.

The guide function of the block is entrusted to a structural guide (m) integrated in the support structure.

In the example in FIG. 2 the holding appendices (c) are arranged radially with respect to the pulley of the block, while the guide function of said block is directly executed by a projection of the sides of the support structure that acts on two extensions of the pin of the block, or in any case on similar lateral projections by means of a dovetailed concave guide. In this configuration, the synchronous closing of the hooks is carried out by the block that, by pushing against the upper prong of each makes the rotation movement symmetrical, while simultaneously the pin raises the lever (K) and reloads the hydraulic controlled release device.

The function of this mechanism is to maintain the hooks in a closed position by exerting an ascending reaction on them with the load, namely with the forces that aim to open the hooks.

It is possible to have multiple mechanical devices suitable for carrying out this function, such as levers of different types, radial or axial cams, plugs, stop pegs or teeth, which are among those in the Figures representing certain preferred solutions.

The levers system offers the best guarantee in terms of strength, duration, reliability and mechanical efficiency, understood as a relation between the force applied for releasing the mechanism and the load applied to the block. In fact the lever system allows friction to be minimised (exclusively of the rolling type) and simultaneously also allows a further reduction of the forces necessary for loaded release (secondary force reduction mechanism).

In the illustration in FIG. 1, the locking mechanism is carried out by means of a lever (k) hinged to one end directly with one of the hooks (o) and at the other end to a short connecting rod (i) that in turn is hinged to the other hook (o).

The hinges (o) on the hooks are placed in an intermediate position between the fixed hinge (h) and the hook peak, as described in the hooking mechanism.

The closing movement of the lever mechanism is executed by the push itself of the block on the longer lever (k), which causes the simultaneous closure of the hooks.

The ascending movement of the block is therefore locked by an appropriate stopper housing situated at the top of the structural guide (m) when the hinge common to the two levers (q) has gone beyond the dead point formed by the alignment of the three hinges (q,o,o).

An appropriate elastic organ (peg or ball with a compressed spring (j), tension spring or other similar combinations) maintains the two levers in their final configuration, preventing these, under the effect of pushes or vibrations, from subsequently being lowered thus allowing the loadless opening of the hooks, in the intermediate descending stage of the block (b) from the position in which lifting is complete to the rest position.

The levers (k, i) remain therefore in the hook locking position (a) until the application of a suitable direct downward force causes lowering below the dead point and therefore the sudden opening of the hooks (a).

It is clear from the Figures that by discharging the tension of the lifting cables, the block is lowered and the holding appendices come into contact with the hooking surfaces. The result of the forces applied induced by the load will therefore aim to open the hooks by forcing the two levers to ascend further, but these will be countered by the strong mechanical stop (u) located on the support structure.

Generally, the release control will be carried out by applying a suitable force on the locking mechanism in order to bring about the movement from the closed position to the open position, by overcoming the resistance forces possibly induced by the load and by the resultant friction.

The controlled release devices will be of the manual type or will have an actuator. The release devices consisting of suitable actuators supplied by energy reserve and mainly remote controlled systems represent the devices used for ordinary service, namely those regularly used under normal operating conditions. The release devices operated instead with manual-type mechanisms will be used in an emergency, understood as a situation requiring forced release in the event of the malfunctioning of the ordinary release device.

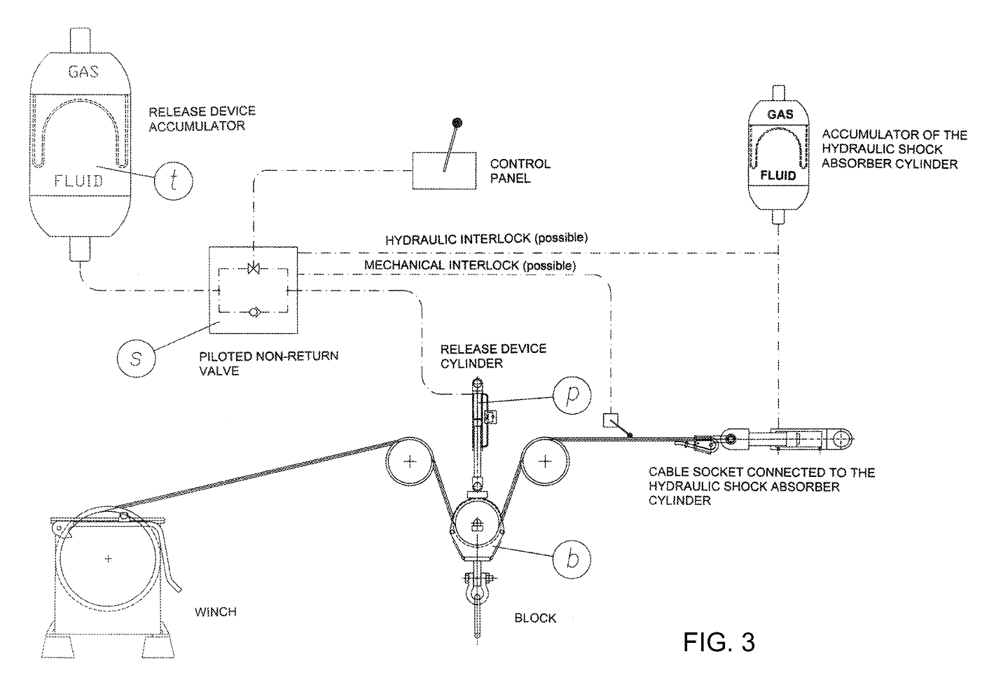

The energy reserve system that supplies the ordinary release devices is commonly of the hydraulic type. This system will consist of a hydraulic cylinder (p) that, on the command to release, will promptly be supplied with the pressured fluid provided by the energy reserve system, consisting in turn of an accumulator (t) pressurised with inert gas. According to the specific requirements of the application and of the loads applied to the block (b), the hydraulic circuit can be of the open type, namely connected to a hydraulic centre that provides for the loading of the accumulator each time the actuator cylinder is activated, or it can be of the closed type (FIG. 3) in which the pressurised fluid flows from the accumulator, generally similar to a pocket (t), to the cylinder (p) and vice-versa. When possible, whether for safety or cost related reasons, the latter configuration will preferably be used.

The controlled block release device disclosed in the Figures given is of the closed circuit type, particularly suitable for use in fixed type lifeboat lowering devices. In these devices, the reloading of the pressurised accumulator (t) is automatic, this being obtained by means of the ascending movement of the block (b), either by means of the direct effect of the block on the shaft of the cylinder (p), or through an indirect effect by means of the levers (k) and (i) of the hook locking mechanism (a).

A non-return valve (s) is provided between the hydraulic cylinder and the accumulator, possibly of the piloted type, that allows the free passage of the fluid from the cylinder to the accumulator but blocks any opposite flow as long as the pilot device or a remote-controlled bypass valve, as disclosed in the cited Figures, does not allow the fluid to flow from the accumulator to the cylinder.

If the block (b) rests on the hooks (a), the push of the cylinder (p) will cause the opening of the mechanism that holds it in a locked state (levers, cams etc.) and therefore the release of the block. If instead the block is in the raised position with respect to the support surface (e), the push of the cylinder will not be able to open completely the hook locking mechanism since the release mechanism is resting on the block. In the extreme case in which the block is still in its maximum elevation position on completion of lifting, the push of the cylinder will not have any apparent effect as long as the block is not be lowered. In this case the hooking mechanism will open gradually as the block is lowered with a movement inverse to that executed during the closure stage.

The hydraulic braking function is also assigned to the controlled release device, namely controlling the opening speed of the hooks. The need for this braking device resides in the fact that, at the point of block release, the cables could be loosed, even if not completely loose. In this case, with the locking mechanism open, the holding appendices of the block would aim to accelerate the opening of the hooks with a trigger release action, by means of which the resulting dynamic forces could become detrimental to the automatic hooking device and to the lifting system itself.

In the Figures mentioned the hydraulic braking device is illustrated with a small hydraulic block (r) inserted into a connection between the two chambers of the actuator cylinder. The small block (r) consists of a flow valve bypassed by a non-return valve.

During the closure of the cylinder, the push of the block causes the movement of the hydraulic fluid from the cylinder to the accumulator, which is thus reloaded automatically. However, the fluid pressure in the upper chamber simultaneously allows the passage, by means of the non-return valve, of a small flow from the upper chamber to the annular chamber, which will therefore always be full. In fact, the fluid could also flow down into the annular chamber by means of the flow valve, as in fact always takes place to a small extent, but the weakening of the entire flow would produce an additional resistance on the block requiring, in the final analysis, the over-dimensioning of the lifting system.

For the opening of the hooking device it is necessary for the accumulator to pressurise the upper chamber of the cylinder. The resultant push on the piston, in addition to overcoming the opposite resistance from the hook locking mechanism, creates a strong overpressure in the annular chamber. This overpressure obliges the fluid to move from the annular chamber to the upper chamber, passing however through the flow valve. By opportunely calibrating the flow valve, the emission of the shaft will be achieved at a controlled speed by which, also with the block rested on the hooks, the hydraulic braking will significantly limit acceleration by eliminating or reducing the drawbacks.

In the event of the loss of the accumulator it is known that with the consequent need to resort to the manual release device, this hydraulic braking device may still advantageously carry out its function.

Although the hydraulic braking device described above is suitable for preserving the integrity of the automatic hooking system, it is suitable for preventing the block from being released with the cables completely loosened in order to avoid the temporary fall of the load and therefore the occurrence of dangerous overloading on the lifting system. Therefore, it is also useful to provide a possible interlock in the opening control of the release mechanism. This interlock can be carried out with suitable mechanics or hydraulic systems, for example connected to the shock absorber cylinder circuit placed between the fixed cable socket of the lifting cable and the support structure, namely by means of suitable feelers that act directly on the lifting cable. Such interlock devices are schematically indicated in FIG. 3.

An effective interlock device in the event of the loosening of the lifting cable could not however be an alternative to the hydraulic braking device, since the latter carries out a direct safety action on the release device, substantially independent of whether opening is hydraulically or manually actuated. Moreover, in the case of lowering devices with two blocks, the greater or lesser slackness of one of the two lifting cables could give rise to a situation in which one of the two blocks is unhooked while the other remains locked. Taking into account this possibility, it is clear that a control device with a release mechanism and possibly the interlock must exert a synchronised action on both hooking devices.

The purpose of the support structure is to house the hooking mechanism and the hook locking mechanism, while also acting as a support for the hydraulic cylinder of the controlled block release device, by connecting the assembly tightly to the structures of the crane or the fixed lifting installation.

The guide is also integrated into the support structure, said guide serving to correct possible misalignments of the block by repositioning it to its correct entrance position and by guiding it vertically until reaching the position of maximum elevation. This guide will be able to operate directly on the mushroom-shaped head placed above the block (FIG. 1), on the holding appendices and on the pin of the block (FIG. 2) or, more generally, on a combination of surfaces and projections suitably prearranged on the block.

When the hooking device is closed, the support structure will also have to provide suitable housing, partial or total, for the block. In virtue of this, particularly for the installations intended for lifesaving means, the support structure must be also shaped in such a way as to allow the free transverse orientation of the block according to the tilted directions assumed by the load, according to the variable trim of the ship, within the limits established by current regulations.

All the rebates will also be provided in the support structure, said rebates acting as a mechanical stop for the different moving organs and also being necessary for the correct working of the hooking mechanism and the release mechanism. In addition to this, the support structure will also provide suitable housing for the auxiliary accessories, such as the elastic holding organs, the sensors etc.

The particular shape assumed by the support structure will essentially depend on the type and on the geometry of the mechanisms used as well as on the characteristics of the installation on which the automatic hooking device is to be mounted.

The structural guide is extended vertically until it reaches an upper centering hollow while, towards the lower part, it is divaricated with two tilted dovetailed sections that force the blocks, possibly screwed or laterally misaligned, to assume the correct entrance position during the ascending movement. This warning is necessary since the cables may have internal twists, which cause the block to develop in a rotated position with respect to the vertical axis that is also in the proximity of the suspension pulleys; without including the more or less extensive oscillations caused by the load subjected to maneuvers or exposed to the wind or to the rolling of the ship. Moreover, during the opening stage, the block can assume an inclined trim with respect to the hooking device, both while it is still hooked and as well as immediately after the release of the hooking mechanism. Therefore, the lower sections of the structural guides must also accompany the block when it moves laterally, avoiding dangerous jolts during the stage in which the block moves away from the hooking device.

1. An automatic hooking device with a block locking mechanism comprising:
automatic hooking means operated only by the ascending movement of the block that is opportunely guided, said hooking means including at least hook clamping means that act on projections and/or the head of said block for the hooking of said block and,
locking means constituting an automatic locking device in a steadily closed position of the first hooking means, actuated by the same ascending movement of said block and consisting of a mechanism suitable for assuming and permanently maintaining the clamped closing position of said hook clamping means;
release means capable of releasing said second locking means following a power-assisted manual command,
wherein, said locking means are operating levers hinged to each other and to said hooks, configured in such a way as to prevent the opening of said hooks under the effect of the load, in virtue of their stably balanced position in the proximity of the alignment point of three hinges.

2. The automatic hooking device according to claim 1, wherein said release means include a hydraulic cylinder system that acts on the locking mechanism of said hooking means and is connected to a hydraulic energy reserve system supplied by a permanently gas-pressurised hydraulic accumulator.

3. The automatic hooking device according to claim 1, wherein said automatic hooking means and locking means are made up of a couple of opposing hooks arranged in a jaw shape in association with said operating levers hinged to each other and to said hooks, configured in such a way as to prevent the opening of said hooks under the effect of the load, in virtue of their stably balanced position in the proximity of the alignment point of the three hinges.

4. The automatic hooking device according to claim 2, wherein said hydraulic reserve energy device is of the closed type, consisting of a hydraulic accumulator in which the pressurised fluid flows from the accumulator to the cylinder during the release stage of said hook clamping means and in the opposite direction during the reentry stage of the block, the fluid only flowing in one direction during the loading stage and the return of said liquid being prevented by the cylinder that has a non-return valve.

5. The automatic hooking device according to claim 1, wherein hydraulic braking means are provided for controlling the opening speed of the clamping hooks.

6. The automatic hooking device according to claim 1, further comprises a hydraulic interlock device, deactivated by overpressure in the tensioner cylinder circuit of the fixed cable socket, or a mechanical device with a suitable cable feeler, appropriate for preventing said release control of the hook locking mechanism from clamping the block if the cables are loosened.

7. The automatic hooking device according to claim 1, wherein said hook clamping means or hooks are made up of a lower hook positioned opposite a fixed pivot in an upper position and movable pivots in an intermediate position.

8. The automatic hooking device according to claim 1, wherein said hooks are made up of hook clamping means with a lower hook positioned opposite a fixed pivot in an intermediate position and said movable pivots in an upper position.

9. The automatic hooking device according claim 1, wherein the operating means of said hook clamping means have a couple of upper levers.

10. The automatic hooking device according to claim 9, wherein said upper levers provides an asymmetric mechanism in which one lever is articulated to the second in such a way that when raised from the rabbet of said block, said first lever also operates said second lever thus determining the tightening of said hook clamping means.

11. A crane comprising at least one automatic hooking and release device according claim 1.

12. A block crane for lifeboats comprising at least one automatic hooking and block release device according to claim 1.

13. A ship equipped with at least one crane according to claim 12.
